(19) United States
(12) Patent Application Publication
(10) Pub. No.: US 2010/0071070 A1
(43) Pub. Date: Mar. 18, 2010

(54) Managing Sharing of Media Content From a Server Computer to One or More of a Plurality of Client Computers Across the Computer Network

(76) Inventors: Amandeep Jawa, San Francisco, CA (US); Timothy Benjamin Martin, Sunnyvale, CA (US); Jeffrey L. Robbin, Los Altos, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/555,710

(22) Filed: Sep. 8, 2009

Related U.S. Application Data
(63) Continuation-in-part of application No. 11/031,754, filed on Jan. 7, 2005.

(51) Int. Cl. H04L 9/00

(52) U.S. Cl. 726/26

(57) ABSTRACT

Improved techniques to manage or restrict sharing of media assets over a network are disclosed. A server computer having media assets can permit one or more clients to receive access to such media assets over a computer network. However, the access to such media assets can be restricted based on numerical limits as well as temporal limits. The media assets can, for example, be digital media assets, such as audio items (e.g., audio files, including music or songs), videos (e.g., movies) or images (e.g., photos).

### CROSS-REFERENCE TO OTHER APPLICATION

This application is a Continuation-In-Part of U.S. patent application Ser. No. 11/031,754, filed Jan. 7, 2005, entitled “RESTRICTED MEDIA SHARING OVER NETWORKS”, which is herein incorporated by reference.

### BACKGROUND OF THE INVENTION

1. Field of the Invention

The present invention relates to media sharing and, more particularly, to management of media sharing across a network.

2. Description of the Related Art

A computer, referred to as a host computer, can serve to enable a user to manage, play and share media assets. As an example, the host computer can execute a media management application to manage, play and share media assets. One example of a media management application is iTunes®, produced by Apple Inc. Often, a media player can acquire its media assets from the host computer. The host computer can also enable a user to manage the media assets to be provided on the media player.

Digital rights management (DRM) refers to access control technologies used by media content publishers to implement reasonable limitations on unauthorized access, use or redistribution of digital media content. While most people agree that some digital rights management is needed, some convenience and flexibility is desired to balance comprehensive digital rights management, especially in a context of a person's home environment. For example, in a home environment a husband and wife may each have their own computers, and their own iTunes® store accounts for purchasing and downloading media content. In addition, a family may further include four children, each with their own computer and iTunes® store accounts. The respective computers of each of the family members may already be networked together in a home network. However, family members may want an easy and convenient way to share recent purchases of digital media content with other family members.

Thus, there is a need for improved techniques to manage media sharing between different computers.

### SUMMARY

The invention pertains to improved techniques to manage or restrict sharing of media assets over a network. A server computer having media assets can permit one or more clients to receive access to such media assets over a computer network. However, the access to such media assets can be restricted based on numerical limits as well as temporal limits. The media assets can, for example, be digital media assets, such as audio items (e.g., audio files, including music or songs), videos (e.g., movies) or images (e.g., photos).

The invention can be implemented in numerous ways, including as a method, system, device, or apparatus (including graphical user interface or computer readable medium). Several embodiments of the invention are discussed below.

As a computer implemented method of managing sharing of media content from a server computer to one or more of a plurality of client computers across a computer network, one embodiment includes at least the acts of: downloading media content to the server computer; storing media content in long-term storage in the server computer; discovering a first set of a plurality of trust attributes of the server and a second set of a plurality of trust attributes of a particular one of the client computers; and upon determining that the first and second sets of trust attributes satisfy a trust criteria, trusting the particular client computer, and aggregating media content from the server computer to long-term storage of the particular client computer.

As a computer implemented method for restricting sharing of media content from a server computer to one or more of a plurality of client computers across a computer network, another embodiment includes at least the acts of: downloading media content to the server computer; storing media content in long-term storage in the server computer; determining whether at least one of a limited number of trust slots is available for use by a particular client computer; assigning an available one of the trust slots for use by the particular client computer when said determining determines that at least one of the limited number of trust slots is available for use by the particular client computer; establishing a connection for the particular client computer using the assigned trust slot; sharing media content from the server computer with the particular client computer via the established connection; and reserving the assigned trust slot for the particular client computer for at least a predetermined period of time after an event.

As a context aware computer implemented method of managing sharing of media content from a Digital Rights Management (DRM) server computer to one or more of a plurality of client computers across a computer network, another embodiment includes at least the acts of : downloading media content to the DRM server computer; storing media content in long-term storage in the DRM server computer; discovering a plurality of time dependant and/or location dependent and/or event dependent attributes of a trust context of the DRM server and a particular one of the client computers; determining whether the plurality of attributes of the trust context of the DRM server and the particular one of the client computers satisfy a trust criteria; and sharing media content from the server computer with the particular client computer if the determining determines that the trust criteria is satisfied.

As a computer readable medium including at least computer program code stored thereon for managing sharing of media content from a Digital Rights Management (DRM) server computer to one or more client computers across a computer network, one embodiment includes at least: computer program code for discovering a plurality of attributes of a trust context of the DRM server and a particular one of the client computers; and computer program code for sharing media content from the server computer with the particular client computer, upon determining that the plurality of attributes of the trust context of the DRM server and the particular one of the client computers satisfy a trust criteria.

As an electronic device, one embodiment of the invention includes at least: a network interface for coupling said electronic device to a computer network; a memory for storing media content; digital rights management control logic configured to permit limited sharing of at least a portion of the media content stored in the memory to one or more other electronic devices coupled to the computer network; and trust attribute discovery logic configured to discover a plurality of attributes of a trust context of the electronic device and a particular one of the other electronic devices. The digital rights management control logic is further configured to share at least a portion of the media content stored in the memory to the particular one of the other electronic devices, upon determining that the plurality of attributes of the trust context of the particular one of the other electronic devices satisfy a trust criteria.

As a computer implemented method for restricting sharing of digital media assets across one or more networks, another embodiment includes at least: establishing a limited group of computers permitted to share digital media assets across one or more networks; purchasing, via a first computer from the limited group of computers, a digital media asset from a media commerce service; permitting the purchased media asset to be provided to any of the other computers within the limited group of computers; and automatically providing the purchased media asset to any of the other computers within the limited group of computers when connected to the one or more networks.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a block diagram of the media sharing system according to one embodiment.

FIG. 1B is a flow diagram of a media sharing process according to one embodiment.

FIGS. 1C-1E are simplified block diagrams illustrating media sharing authorization of the server computer.

FIG. 1F shows an exemplary text record.

FIG. 1G is a screen shot of a graphical user interface.

FIG. 1H is another block diagram of the media sharing system according to one embodiment.

FIG. 2A is a flow diagram of a media sharing process according to one embodiment.

FIG. 2B is a flow diagram of a process for determining the required authorization of the un-trusted client computer.

FIGS. 3A and 3B are flow diagrams of a media sharing login process according to one embodiment.

FIG. 4 is a flow diagram of a media sharing logout process according to one embodiment.

FIG. 5 is a diagram of a reservation table according to one embodiment.

FIG. 6 is a block diagram of a media management system according to one embodiment.

### DETAILED DESCRIPTION OF THE INVENTION

The invention pertains to improved techniques to manage or restrict sharing of media assets over a network. A server computer having media assets can permit one or more clients to receive access to such media assets over a computer network. However, the access to such media assets can be restricted based on numerical limits as well as temporal limits. The media assets can, for example, be digital media assets, such as audio items (e.g., audio files, including music or songs), videos (e.g., movies) or images (e.g., photos).

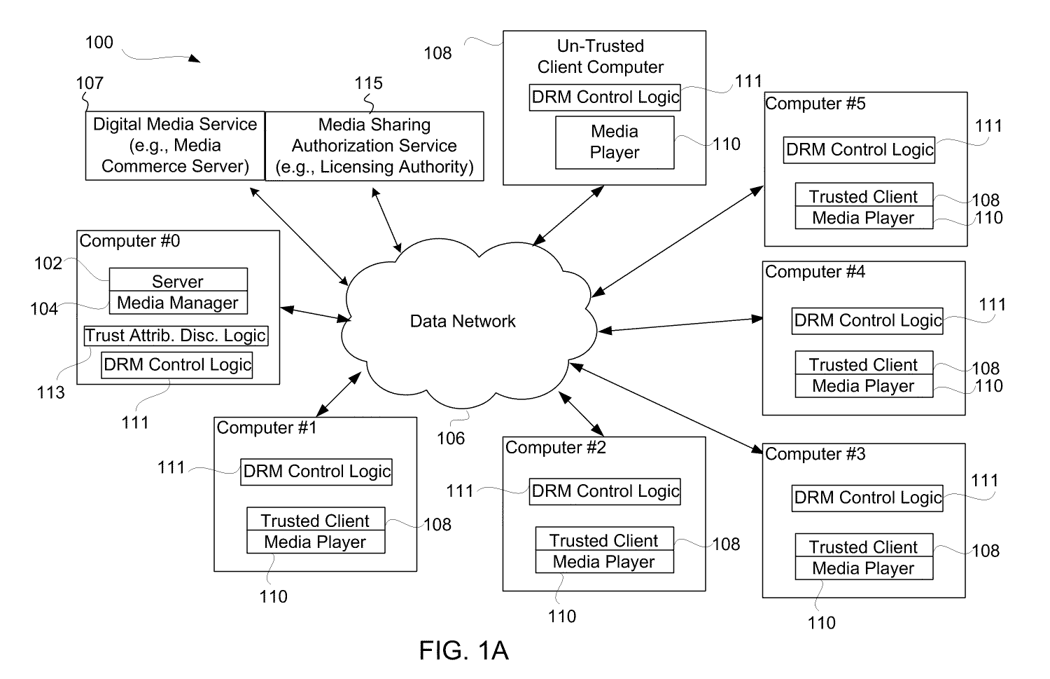

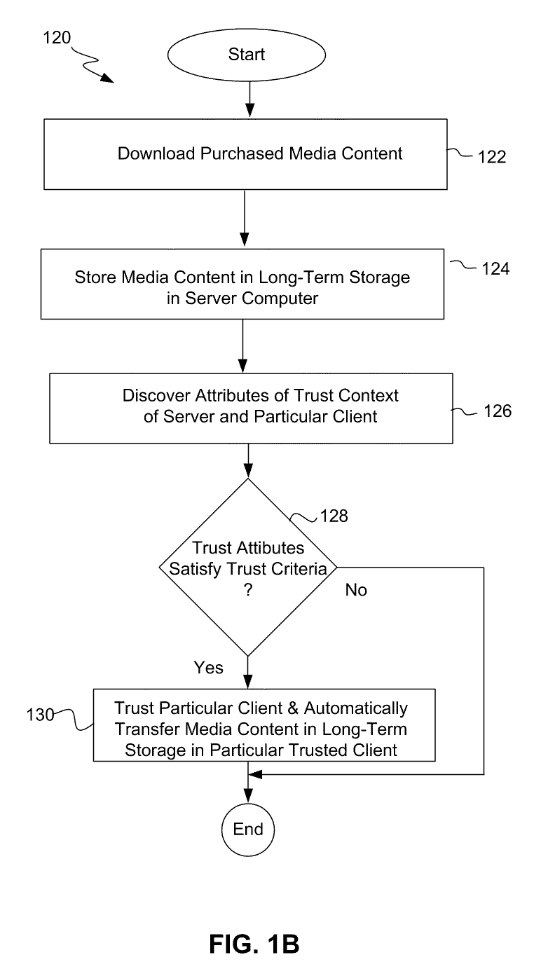

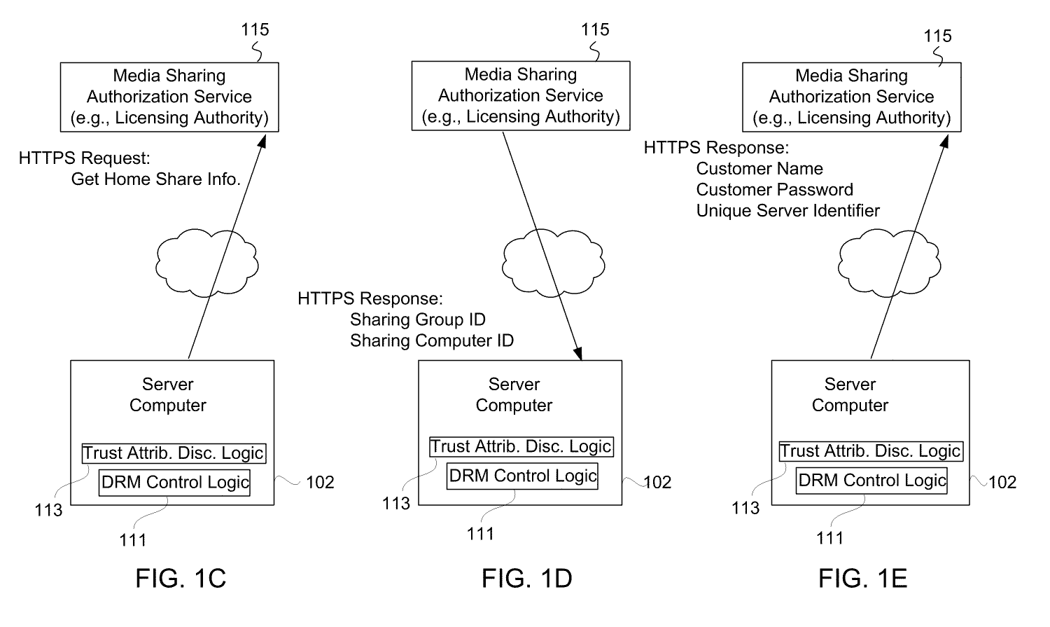

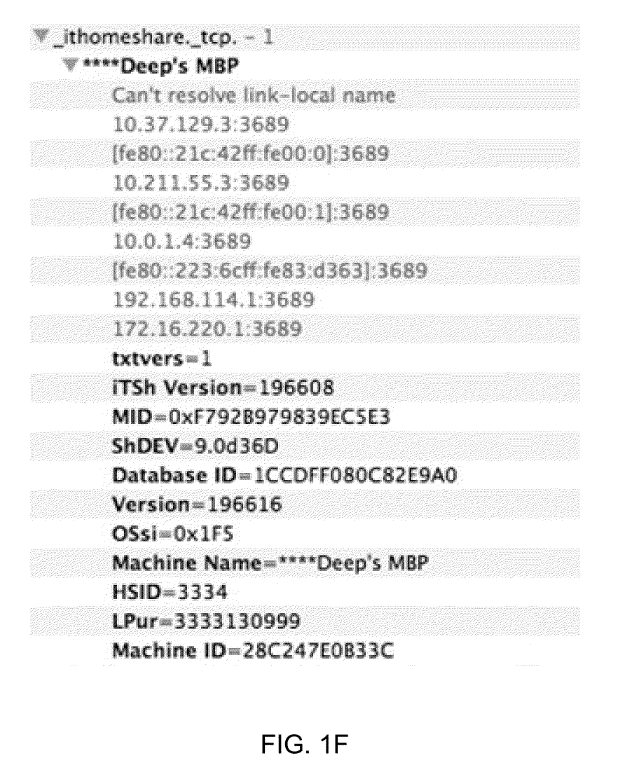

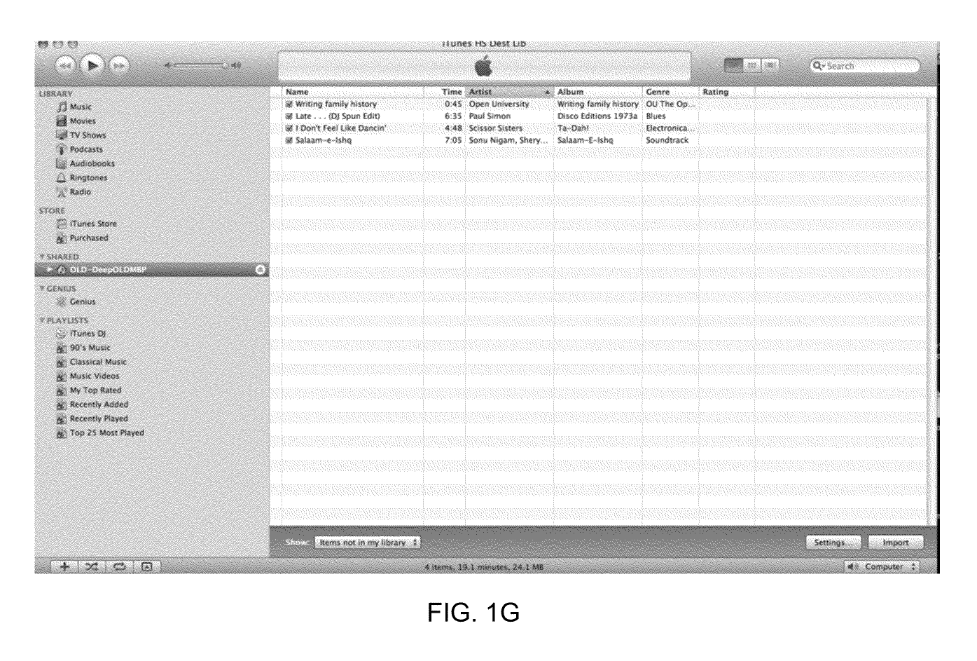

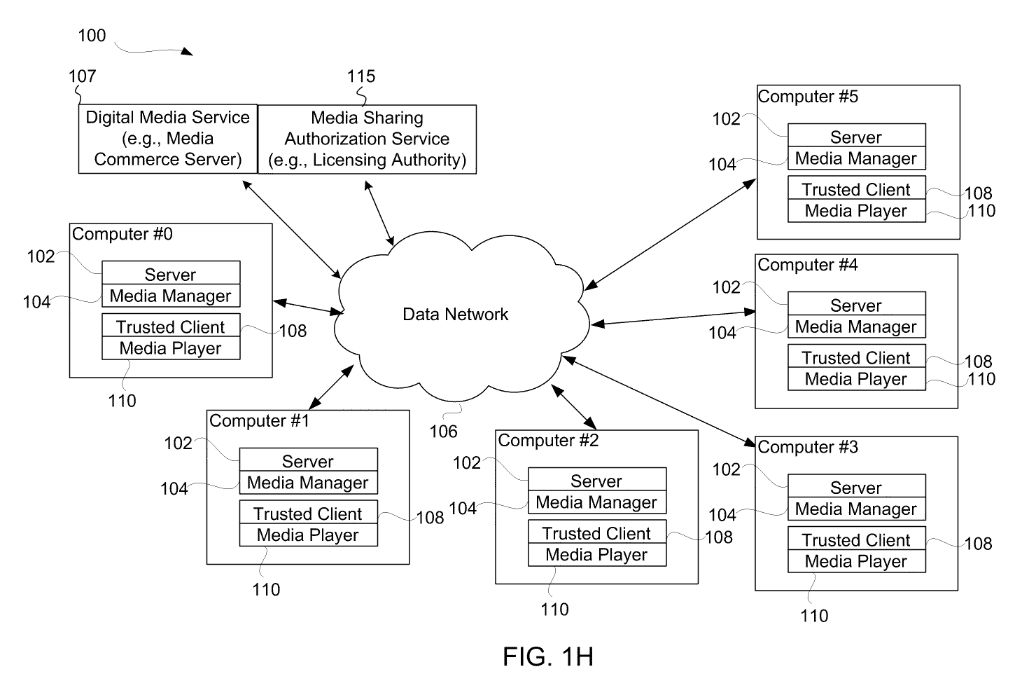

Embodiments of the invention are discussed below with reference to FIGS. 1-6. However, those skilled in the art will readily appreciate that the detailed description given herein with respect to these figures is for explanatory purposes as the invention extends beyond these limited embodiments.

FIG. 1A is a block diagram of the media sharing system 100 according to one embodiment. The media sharing system 100 includes a server computer 102 that operates a media manager 104. The server computer 102 may comprise a server instance hosted by a first computer, designated as Computer #0. The media manager 104, among other things, controls the sharing of media content that is stored on the server computer 102. The media content pertains to media assets, such as audio tracks. Typically, the media manager 104 can also perform other media management functions, such as assisting a user with organization of media content as well as locally playing the media content at the server computer 102. The server computer 102 can also couple to a computer data network 106. In one embodiment, the computer network 106 can pertains to a Local Area Network (LAN). In other embodiments, the computer data network 106 can pertain to an Ad Hoc network, a home network, a wireless network, a cellular data network, a Wide Area Network (WAN), and/or the Internet.

A digital media service, for example a media commerce server 107, coordinates review, purchase, and/or rental of media content through on-line transactions. On-line transactions to purchase media content are also referred to as electronic commerce (e-commerce). The server computer may comprise an electronic device. The electronic device may comprise a memory for storing media content and a network interface for coupling the electronic device to the computer data network 106. Purchased media content may be downloaded from the media commerce server 107, over the computer data network 106, to the server computer 102. Such downloaded media content may be stored in the memory. The memory may comprise long-term storage in the server computer 102.

In addition, the media sharing system 100 also includes one or more client computers 108. The client computers 108 can also couple to the computer data network 106. Each of the client computers 108 includes a media player 110. As will be discussed in further detail subsequently herein, the client computers 102 may comprise a one or more trusted client instances hosted on computers as well as any un-trusted client instances hosted on any computers.

In one embodiment, restrictions can be implemented such that only a limited number of trusted client computers at any given point in time can receive the shared media content from the server computer 102 via the computer data network 106. As an example, the restrictions could set the limited number of trusted client computers to not exceed five (5). For illustrative purposes of such example, FIG. 1A shows a limited number, e.g. five (5), of client instances, each hosted on a respective one of a limited number, e.g. five (5), client computers (computers #1 through #5 in FIG. 1A.)

The media player 110 within the client computer 108 is able to receive shared media content from the server computer 102 via the computer data network 106. For example, in one implementation, the media player 108 receives shared media content that is shared by the server computer 102 over the computer data network 106 to one or more of the client computers 108. Typically, the media player 110 can also enable a user of the client computer 108 to manage and play media content stored locally.

In one embodiment, the media manager 104 is a media management application to manage and share media assets. In one embodiment, the media player 110 can receive shared media content via the computer data network 106 and effect locally playing the shared media content, such as for the user of the client computer 108. The media player 110 can also store media assets, such as audio tracks or photos, that can be played or displayed on the media player 110.

Additionally, once a particular client computer 108 is permitted to receive the shared media content from the server computer 102, the particular client computer 108 is deemed to have taken a trust slot of a limited number of trust slots. Thereafter, when the particular client computer 108 no longer participates in the receiving of the shared media content from the server computer 102, the associated trust slot is no longer needed by the particular client computer 108 and could be released. However, instead of completely releasing the associated trust slot, the associated trust slot can be deemed reserved for the particular client computer 108. For example, the associated trust slot can be deemed reserved for a predetermined reservation period (e.g., 24 hours, 48 hours, one week, one month or longer). As a result, the ability for numerous anonymous client computers to participate in receiving shared media content from the server computer 102 is hindered because the turn-over rate of the limited number of trust slots is restricted.

Accordingly, the media sharing system 100 can restrict the ability of the client computers 108 to receive shared media content from the server computer 102. In this regard, the restrictions can be interposed so that a user of the server computer 102 is encouraged to be more responsible in their sharing of media content across the computer network 106. For example, the user of the server computer 102 might be encouraged to impose passwords on those of the client computers 108 that desire to receive, and thus share, the shared media content being provided by the server computer 102. More particularly, in one embodiment, the restrictions can be such that only a limited number of the client computers 108 at any given point in time can receive the shared media content from the server computer 102 via the computer data network 106. As an example, the restrictions could set the limited number of the client computers 108 to not exceed five (5), i.e., five trust slots.

Client computers that do not have trust slots assigned to them (or reserved for them) may be designated as un-trusted client computers. Since the number of trust slots is limited, client computers in numbers exceeding the limited number of trust slots may be designated as un-trusted client computers. For example, the limited number of trust slots may be for example five (5) slots; the limited number of trusted client computers may be for example five (5) trusted computers, wherein each one of the limited number of five (5) trust slots may be assigned to a respective one of the five (5) trusted computers; and an additional client computer, for example a sixth client computer, may be in excess of the limited number of trust slots and may be designated as an un-trusted client computer as shown in FIG. 1A. Such un-trusted client computers may be restricted from receiving shared media content from the server computer 102.

The trust slots, and control of their operation may be provided by Digital Rights Management (DRM) control logic 111, which may be embodied as a centralized application or service, or as a distributed application or service. For example, as shown in FIG. 1A, DRM Control Logic 111 may operate in a distributed manner in the server computer 102 as well as the client computers 108. The digital rights management control logic may be configured to permit limited sharing of at least a portion of the media content stored in the memory of the server computer 102 to one or more other electronic devices coupled to the computer data network 106. For example, the DRM control logic may be configured to permit limited sharing of at least a portion of the media content stored in long term storage memory of the server computer 102 to long term storage memory of one or more other electronic devices, comprising the trusted client computers 108 coupled to the computer data network 106.

In discussions of the DRM control logic 111, and well as discussions other logics herein, it should be understood that “logic”, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic.

The electronic device, may be associated with the server computer 102 as discussed previously herein, and further may be a context aware electronic device. Other electronic devices, may be associated with the client computers 108, and further may be context aware electronic devices. Trust attribute discovery logic 113 may provide for such context awareness, and may be configured to discover a plurality of time dependant and/or location dependent and/or event dependent attributes of a trust context of an electronic device and a particular one of the other electronic devices (and/or such attributes of respective trust contexts of other ones of the other electronic devices). Trust attribute discovery logic may be embodied as a centralized application or service, or as a distributed application or service. As shown in FIG. 1A, trust attribute discovery logic 113 may be associated with server computer 102. In alternative embodiments the trust attribute discover logic can operate in a distributed manner in the device, which may be associated with the server computer 102 as well as in the other electronic devices, which may be associated with the client computers 108.

The DRM control logic 111 may be further configured to share at least a portion of the media content stored in the memory of the device, which may be associated with the server computer 102, to the particular one of the other electronic devices, upon determining that the plurality of attributes of the trust context of the particular one of the electronic devices satisfy a trust criteria. Accordingly, such DRM control logic may be employed in the server computer 102, which may operate as a DRM server computer, and may provide for one or more context aware computer implemented methods of managing the sharing of media content from the DRM server computer to one or more of a plurality of client computers across the computer data network 106. In accordance with previous discussions herein, the media content may be downloaded to the DRM server computer and stored in long-term storage therein. Upon determining that the plurality of attributes of the trust context of the DRM server computer and the particular one of the client computers satisfy the trust criteria, the DRM server computer may share media content with the particular client computer.

The trust attribute discovery logic 113 may be configured for discovering a first set of a plurality of trust attributes of the server computer and a second set of a plurality of trust attributes of a particular one of the client computers (and/or respective second sets of trust attributes of other ones of the client computers.) The DRM control logic 111 can be configured for determining that the first and second sets of trust attributes satisfy the trust criteria, and for trusting the particular client computer (and/or for determining that the first set of trust attributes and the respective second sets of trust attributes of other ones of the client computers satisfy the trust criteria).

The digital media service (e.g., media commerce server) 107, from which media content was purchased, may be affiliated with a media sharing authorization service 115 (e.g., licensing authority.) In particular, information relevant to the following discussion may be exchanged there between. Additionally, as will be discussed in greater detail subsequently herein, in the determining of satisfaction of the trust criteria, the DRM control logic 111 may cooperate, and may exchange information over the computer data network 106 with the media sharing authorization service 115. In particular, the DRM control logic may exchange trust attribute information and/or trust criteria information and/or trust determination information and/or trust control directive information over the computer data network 106 with the media sharing authorization service 115.

In discovering the first set of the plurality of trust attributes of the server, and determining whether the first set satisfies the trust criteria, the trust attribute discovery logic 113 may be configured for discovering availability of the limited number of trust slots at the server computer 102. The DRM control logic 111 may be configured for determining whether at least one of the limited number of trust slots is available for server connection use by a particular client computer, in accordance with the trust criteria.

Further, in discovering the first set of the plurality of trust attributes of the server, and determining whether the first set satisfies the trust criteria, the trust attribute discovery logic 113 may be configured for discovering any time dependent availability of the limited number of trust slots the server computer, and the DRM control logic 111 may be configured for determining whether the time dependent availability of at least one of the limited number of trust slots is in accordance with the trust criteria. For example, an attribute of availability of trust slots for server connection use by the particular client computer, in accordance with the trust criteria, may be time dependent. As mentioned previously herein, a trust slot may be deemed reserved and unavailable for a predetermined reservation period (e.g., 24 hours, 48 hours, one week, one month or longer).

Additionally, in discovering the first set of the plurality of trust attributes of the server, and determining whether the first set satisfies the trust criteria, the trust attribute discovery logic 113 may be configured for discovering any event dependent availability of the limited number of trust slots the server computer, and the DRM control logic 111 may be configured for determining whether the event dependent availability of at least one of the limited number of trust slots is in accordance with the trust criteria. For example, as will be discussed in greater detail subsequently herein, the trust attribute discovery logic 113 may discover a client sharing service release event affecting trust slot availability.

Moreover, in discovering the first set of the plurality of trust attributes of the server, and determining whether the first set satisfies the trust criteria comprise, the trust attribute discovery logic 113 may be configured for discovering any authorization of the server computer for sharing media content. For example, the trust attribute discovery logic may be configured for discovering authorization over the computer data network 106 from the media sharing authorization service 115. The DRM control logic 111 may be configured for determining whether the server computer 102 is authorized, for example, by the media sharing authorization service 115, for sharing media content, in accordance with the trust criteria.

Similarly, in discovering the second set of the plurality of trust attributes of the particular one of the client computers, and determining whether the second set satisfies the trust criteria, the trust attribute discovery logic 113 may be configured for discovering network connectivity of the particular one of the client computers, and the DRM configuration logic 111 may be configured for determining whether the network connectivity of the particular one of the client computers satisfies the trust criteria. For example, the trust attribute discovery logic 113 may be configured to discover such network connectivity of the computer data network 106, which can use an Ad Hoc network, a home network or a wireless network and can use a zero configuration network protocol and/or a multicast Domain Name System (DNS) protocol and/or a DNS-SD Service Discovery protocol, or some combination thereof.

Using the aforementioned protocols, along with wide area zero configuration networking techniques, and/or by coordinating discovery through enhanced remote networking capabilities of the media sharing authorization service 115, the trust attribute discovery logic 113 may configured to discover such network connectivity of a Wide Area Network (WAN) or a cellular data network. Once discovered, such network connectivity trust attribute information may be transmitted over computer data network 106 to the media sharing authorization service 115, for cooperative trust evaluation with the DRM control logic 111.

Furthermore, in discovering the second set of the plurality of trust attributes of the particular one of the client computers, and determining whether the second set satisfies the trust criteria, the trust attribute discovery logic 113 may be configured for discovering a location, or an approximate location, or an estimate location of the particular one of the client computers. The DRM control logic 111 may be configured for determining whether such location of the particular one of the client computers satisfies the trust criteria. Similarly, the DRM control logic 111 may be configured for determining whether proximity of the particular one of the client computers relative to the server computer is in accordance with the trust criteria.

Additionally, in discovering the second set of the plurality of trust attributes of the particular one of the client computers, and determining whether the second set satisfies the trust criteria comprise, the trust attribute discover logic 113 may be configured for discovering any authorization of the particular one of the computers for sharing media content. For example, the trust attribute discovery logic 113 may be configured for discovering authorization over the computer data network 106 from the media sharing authorization service 115. The DRM control logic 111 may be configured for determining whether the particular one of the client computers is authorized, for example, by the media sharing authorization service 115, for sharing media content, in accordance with the trust criteria.

Upon determining that the first and second sets of trust attributes satisfy the trust criteria, the DRM control logic 111 may be configured for assigning an available trust slot, trusting the particular client computer, and designating the particular client computer as a trusted client computer. The media player 110 of the particular trusted client computer may then be configured for aggregating media content from the server computer in long-term storage in the particular trusted client computer.

FIG. 1B is a flow diagram of a media sharing process 120 according to one embodiment. The process may begin with a download 122 of purchased media content. The process may continue with storing 124 the media content in long-term storage in the server computer. Attributes of a trust context of the server computer and a particular one client computers may comprise the first and second set of trust attributes, which were discussed in detail previously herein. The process may continue with discovering 128 attributes of the trust context of the server computer and the particular one of the client computers. A decision 128 may determine whether the trust attributes satisfy trust criteria. When the decision 128 determines that the trust attributes satisfy the trust criteria, the particular client computer may be trusted and the media content may be automatically transferred 130 (e.g., aggregated) to long term storage in the particular trusted client computer, and the process 120 can end. On the other hand, if the decision 128 determines that the trust attributes do not satisfy the trust criteria, any request by the particular client for media sharing service may be denied, and the process 120 can end.

The transferring 130 of media content may comprise aggregating media content to long term storage in the particular trusted client. Transferring (or aggregating) may comprise downloading media content to the particular client computer, for storing in long term storage in the particular client computer. However, such downloads need only be performed if the media content is not already stored in long term storage in the particular client computer. Similarly, transferring or aggregating may comprise checking a preference setting stored on at least one of the server computer and the particular client computer, and copying media content in long-term storage in the particular client computer only if the preference setting indicates that the media content is to be provided to the particular client computer.

Transferring may be performed automatically and without any specific user input for such transfer. The transferring can also be influenced by one or more preference setting (e.g., set by user or by default) that indicate whether media content is to be transferred in a particular client computer. In accordance with discussions previously herein, Digital Rights Management (DRM) may be enforced by limiting a number of the client computers trusted for aggregating media content therein. Similarly, Digital Rights Management (DRM) may be enforced by limiting a number of trusted ones of the client computers for aggregating media content therein.

Advantageously, the media sharing process 120 facilitates sharing of purchased media content amongst a limited set of client computers. The purchased media content can be shared through aggregation of media content at the client computers. For example, after purchase and receiving media content at one client computer, the received media content can also be provided to one or more other client computers that are deemed trusted, i.e., within an established group of client computers.

FIGS. 1C-1E are simplified block diagrams illustrating media sharing authorization of the server computer 102 over the computer data network by the media sharing authorization service 115. As shown in FIG. 1C, the server computer may transmit a secure HTTPS (HyperText Transfer Protocol Secure) request for Home Share information. Assuming that the media sharing authorization service 115 recognizes the server computer for home sharing, the media sharing authorization service may transmit an HTTPS response over the computer data network to the server computer 102 including a sharing group identifier and a sharing computer identifier for the server computer 102, as shown in FIG. 1D.

However, if the media sharing authorization service 115 does not recognize the server computer, the media sharing authorization service 115 may prompt the server computer 102 for further information. In compliance, the server computer 102 may submit an HTTPS response with a valid customer name, corresponding valid customer password and a unique server identifier for the server computer 102, as shown in FIG. 1E. The unique identifier for the server computer can, for example, be associated with the server computer or a user of the server computer. Some examples of the unique identifier are: a Medium Access Control (MAC) address, an Internet Protocol (IP) address, a device identifier, GUID, a client identifier, or some combination thereof. Upon acceptance of this response, the server computer 102 can again request for home sharing, as already discussed herein with respect to FIG. 1C.

Media content sharing services and home sharing of media content may be published to the client computers 108 by the server computer 102 over the computer data network 106 using, for example, the previously discussed zero configuration network protocol and/or a multicast Domain Name System (DNS) protocol and/or a DNS-SD Service Discovery protocol, or some combination thereof. In one embodiment, in the context of such technology: “A” records map local host names to IP addresses; PTR records are used to enumerate service instances of a particular type; each of the service instances are mapped to the host names and port numbers using SRV records; and TXT records (or Text records) accompany the SRV records, in order to provide additional information about the service instances.

FIG. 1F shows an example TXT record, which may be used by the server computer 102 for publishing media content sharing services to the client computers 108 over the computer data network 106. The HSID (Home Sharing User ID), the MID (Home Sharing Computer ID), the Machine ID, and the Database ID (iTunes® Library ID or media content library ID) shown in the TXT record may be used by the client computers 108 in requesting media content sharing services from the server computer 102. Last Purchase date (LPur) may indicate a date of last purchased media content on the server computer 102, and may be used by the client computers 108 in sharing of recently acquired media content.

FIG. 1G is a screen shot of a graphical user interface that may be displayed on one of the trusted client computers 108 of media content being shared by the server computer 102 with the trusted client computer 108. In providing for transfer (e.g., aggregation) of the media content on the client computer 108, media content items may be displayed in accordance with the legend near the bottom of the display (“Show: Items not in my library”) meaning media items not already stored in long term storage in the client computer 108. Media content for such media items may be manually transferred (e.g., aggregated) in response to user manual selection of controls, or media content may be transferred automatically, without user control selection. The media items available for transfer (e.g., aggregation) may be filtered by the genre of the media content and/or by parental control settings/attributes.

FIG. 1H is another block diagram of the media sharing system 100 according to one embodiment. In order to simplify FIG. 1H as compared to FIG. 1A, the trust attribute discovery logic and the DRM control logic discussed in detail previously herein are not shown, and the un-trusted client computer is not shown. Each client computer (computers #0-#5) hosts a respective server instance as well as a respective client instance. Restrictions can be implemented such that only a limited number of trusted client instances at any given point in time can receive the shared media content from server instances via the computer network 106.

As an example, the restrictions could set the limited number of trusted client instances to not exceed five (5). For example, the server instance on Computer #0 shown in FIG. 1H can share media content with a limited number, e.g. five (5), of client instances, each hosted on a respective one of a limited number, e.g. five (5), of client computers (computers #1 through #5 in FIG. 1H). As another example, the server instance on Computer #1 shown in FIG. 1H can share media content with a limited number, e.g. five (5), of client instances, each hosted on a respective one of a limited number, e.g. five (5), of computers (computers #0 and 1 through #5 in FIG. 1H). Accordingly, as shown in the illustrative example of FIG. 1H, each of the server instances hosted each of the five (5) computers are limited to sharing media content with five (5) client instances hosted on five (5) other computers.

As shown in FIG. 1H, device-based Digital Rights Management (DRM) of the media content for the server computer and the client computers may be enforced by limiting media content distribution between devices of server computers and devices of client computers. As further shown in FIG. 1H connection based Digital Rights Management (DRM) of the media content for the server computer and the client computers may be enforced by limiting network connection sharing between server computers and client computers for media content distribution. Root distribution based Digital Rights Management (DRM) of the media content may be enforced by the previously discussed limits on the medial sharing by each server computer. Leaf distribution based Digital Rights Management (DRM) may be enforced by the previously discussed limits on any media content transferred (e.g., aggregated) on the client computers.

Moreover, Digital Rights Management (DRM) policy may be enforced that restrict access to media content on the server computer for transfer to (e.g., aggregating by) only a limited number of trusted ones of the client computers. Digital Rights Management (DRM) may be enforced by limiting a number of server connections available to trusted ones of the client computers for aggregating media content therein. Digital Rights Management (DRM) may be enforced by limiting a number of trust slots available for server connections to trusted ones of the client computers for transfer of media content.

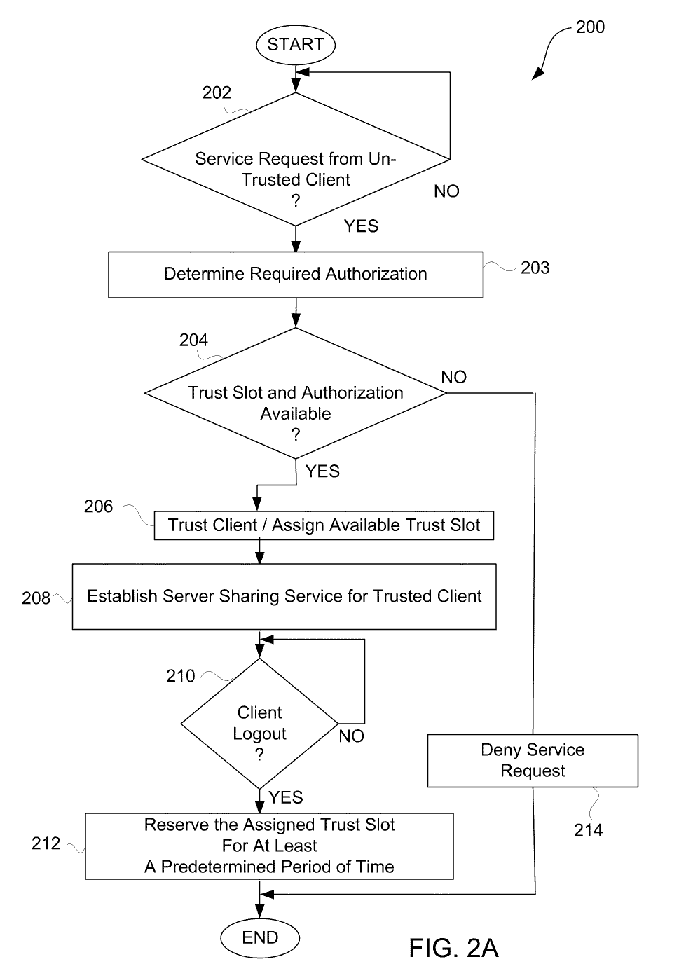

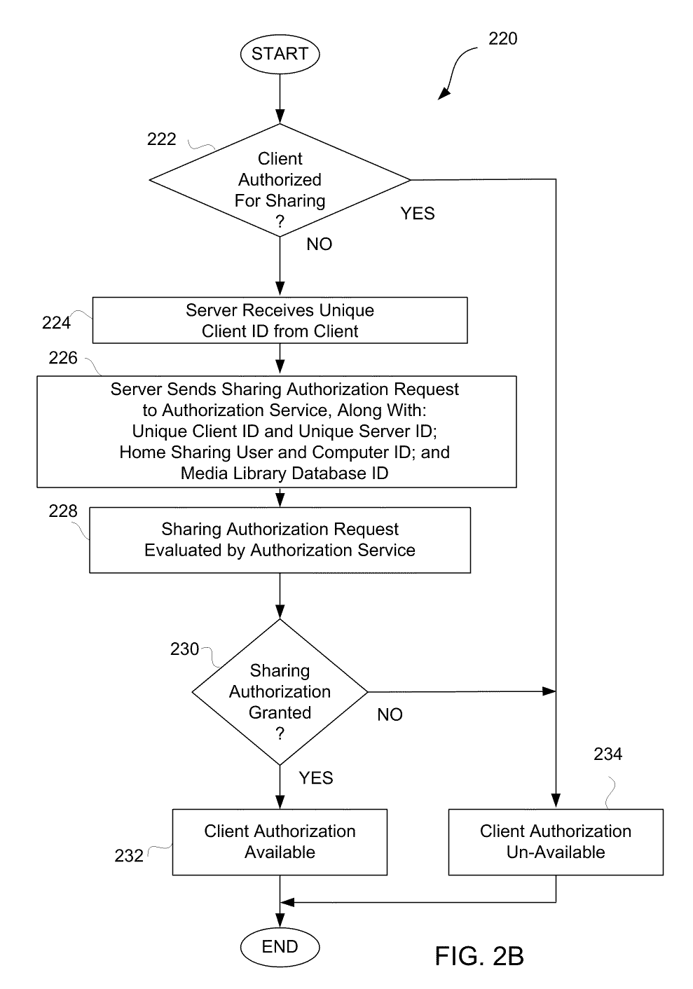

FIG. 2A is a flow diagram of a media sharing process 200 according to one embodiment. The media sharing processed 200 is, for example, performed by a server computer, such as the server computer 102 illustrated in FIG. 1A. In one example, the server computer 102 can be considered an audio server (e.g., music server).

The media sharing process 200 begins with a decision 202 that determines whether a sharing service request has been received by the server computer from an un-trusted client computer. For example, a service request would be provided to the server computer by a client computer that desires to receive media content (i.e., shared media content) from the server computer. When the decision 202 determines that a client connection request has not been received, the media sharing processed 200 awaits such a request. On the other hand, once the decision 202 determines that a sharing service request has been received, the media sharing process 200 continues. Required authorization of the un-trusted client is determined 203.

When the media sharing process 200 continues, a decision 204 determines whether the required authorization is available and whether there it is an available trust slot for the client computer that has requested connection with the server computer. The server computer only has a limited number of trust slots for use by client computers that want to connect with the server computer to share media.

When the decision 204 determines that there is an available trust slot, the available client slide can be assigned 206 to the client computer and thus the client is designated as trusted. Next, server sharing service for the trusted client computer is established 208. Once the sharing service is established 208, the client computer is able to share media from the server computer. A decision 210 then determines whether the client computer has logged out from the service. When the decision 210 determines that the client computer has not logged out, then the media sharing process 200 waits until the client computer has logged out. Here, the server computer can be doing other processing while it monitors for the client computer to log out. As an example, the media sharing process 200 can be implemented as a separate thread that is stalled until the client computer logs out.

In any case, once the decision 210 determines that client computer has logged out, the assigned trust slot can be reserved 212 for at least a predetermined period of time. The predetermined period of time can also be referred to as a reservation period. During the predetermined period of time, only the client computer (should it again request sharing service with the server computer) can again use the trust slot that is reserved for the client computer. After the predetermined period of time, the trust slot that has been reserved can be released and thus reused by any client computer properly seeking connection with the server computer to share media.

Alternatively, when the decision 204 determines that there is no available trust slot for the client computer, then the sharing service request by the client computer is denied 214. Following the block 212 or the block 214, the media sharing process 200 is complete and ends.

FIG. 2B is a flow diagram of a process 220 for determining a required authorization for an un-trusted client computer. The process 220 can represent one embodiment of the determination 203 illustrated in FIG. 2A. The process 220 begins with a decision 222 that determines whether the client computer is authorized for media sharing. If the client computer is not authorized for sharing, the process 220 proceeds to block 234 because the authorization is unavailable, and process 220 can end.

Alternatively, if the client computer is authorized for sharing, the process 220 proceeds and the server computer receives 224 from the client computer a unique client identifier over the computer data network. The unique identifier for the client computer can, for example, be associated with the client computer or a user of the client computer. Some examples of the unique identifier are: a Medium Access Control (MAC) address, an Internet Protocol (IP) address, a device identifier, GUID, a client identifier, a user name, password, or some combination thereof.

Next, the server computer sends 226 a sharing authorization request over the computer data network to the media sharing authorization service, along with: the unique client ID and the unique server ID; the home sharing user and computer ID; and the media library database ID. The media sharing authorization service may evaluate 228 the request for legitimacy and consistency by comparing the information transmitted along with the sharing authorization request to data maintained by the media sharing authorization service. The process 220 then proceeds to decision 230 that determines whether the media sharing authorization service grants sharing authorization for the client computer. If media sharing authorization is not granted, authorization of the client computer for sharing is unavailable at 234 and the process 220 can end. Alternatively, if media sharing authorization is granted, authorization of the client computer for sharing is available 232 and the process 220 can end.

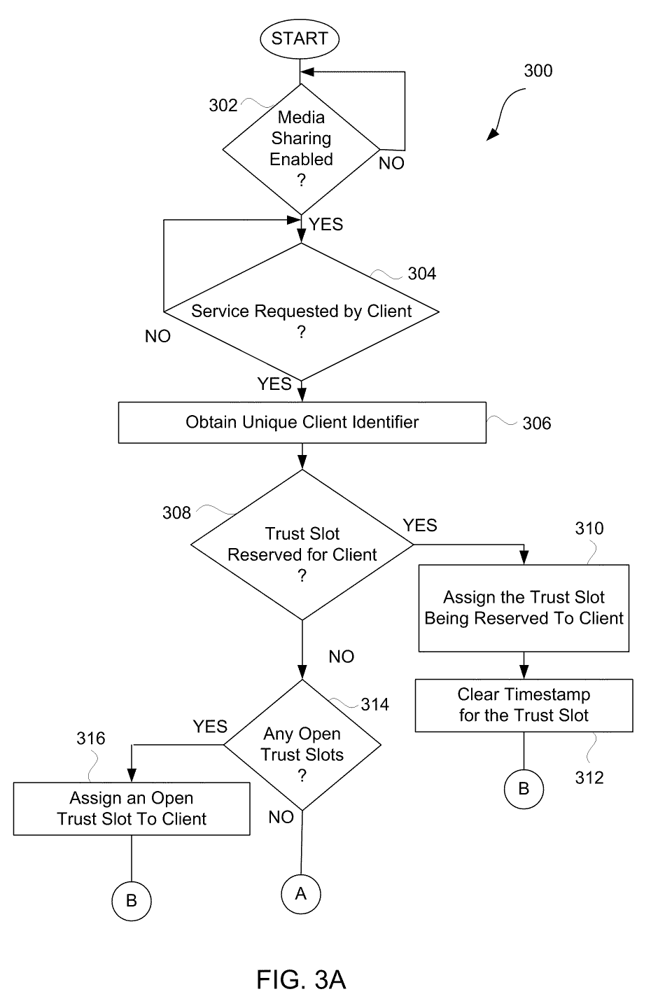

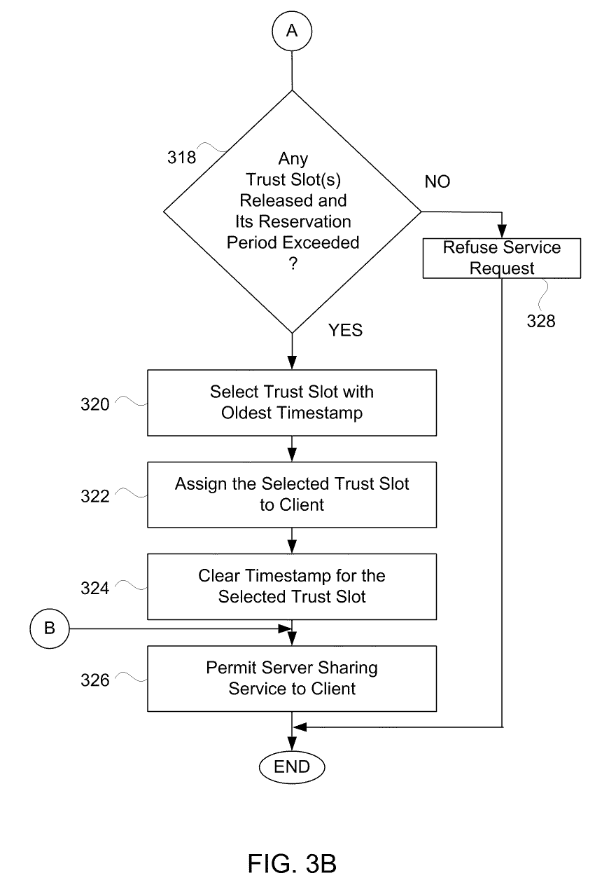

FIGS. 3A and 3B are flow diagrams of a media sharing login process 300 according to one embodiment. The media sharing login process 300 is performed to restrict sharing of media by a server computer. The media sharing login process 300 is, for example, performed by a server computer, such as the server computer 102 illustrated in FIG. 1A. The media being shared in accordance with the media sharing login process 300 is, for example, audio tracks (e.g., music or songs).

The media sharing login process 300 begins with a decision 302 that determines whether media sharing is enabled. Additionally, the server computer, or a user of the server computer, can have the ability to enable or disable the functionality regarding media sharing. When the decision 302 determines that media sharing is not enabled, then the media sharing login process 300 effectively is not invoked because media sharing is not permitted.

On the other hand, when the decision 302 determines that media sharing is enabled, a decision 304 determines whether a client login has been attempted to request the media sharing service. Here, a client computer (e.g., client) attempts to log into a server computer so as to access the shared media from the server computer (e.g., server) via a computer network. When the decision 304 determines that a client login has not been attempted, then the media sharing login process 300 awaits such a client login request.

Alternatively, once the decision 304 determines that a client login has been attempted, a unique client identifier (as discussed previously herein) for the client computer is obtained 306. The unique identifier for the client computer can, for example, be associated with the client computer or a user of the client computer. Some examples of the unique identifier are: a Medium Access Control (MAC) address, an Internet Protocol (IP) address, a device identifier, GUID, a client identifier, or user name and/or password, or some combination thereof. A decision 308 then determines whether a trust slot is being reserved for the client. The trust slot pertains to one of a limited number of trust slots that are available to be utilized by clients. If a client previously used a trust slot offered by the server computer for sharing of media, the trust slot may still be reserved for that same client. Hence, when the decision 308 determines that a trust slot is reserved for the client, the trust slot being reserved for the client is assigned 310 to the client. In addition, a timestamp associated with the trust slot is cleared 312. Here, when a trust slot is reserved for a client, the trust slot is provided with a timestamp associated with its reservation, then when the trust slot that is reserved is subsequently reassigned to the client, the timestamp is cleared 312.

On the other hand, when the decision 308 determines that a trust slot is not reserved for the client, a decision 314 determines whether there are any open trust slots. Here, it should be noted that the number of trust slots available for clients seeking to access the server are limited. For example, the maximum number of trust slots might be five (5), in one example. Hence, when the decision 314 determines that there is an open trust slot, the open trust slot can be assigned 316 to the client.

In another alternative, when the decision 314 determines that there are no open trust slots for sharing media with the server computer, a decision 318 determines whether any of the trust slots have been released and reserved for more than a reservation period. The reservation period can be associated with a predetermined period of time (e.g., 24 hours, 48 hours, one week, one month or longer). When the decision 318 determines that one or more of the trust slots have been released and exceeded their reservation periods, a trust slot with the oldest timestamp is selected 320. The selected trust slot is then assigned 322 to the client. In one implementation, the assignment 322 of the selected trust slot can first be unreserved and then assigned. In addition, the timestamp associated with the selected trust slot is cleared 324.

Following the blocks 312, 316 or 324, the client sharing attempt has been successful because the client has been assigned one of the limited number of trust slots. Having been assigned a trust slot, the client is permitted to receive media (e.g., music or songs) being shared by the server. Hence, the login to the server for media sharing is permitted 326.

On the other hand, when the decision 318 determines that there are no trust slots that have exceeded their reservation period, the login attempt by the client is refused 328. Here, the login request is refused 328 because there are no available trust slots that can be assigned to the client. When there are no available trust slots, which are limited, the login attempt by the client is refused 328 and the client is unable to receive media being shared by the server. Following the blocks 326 or 328, the media sharing login process 300 is complete and ends.

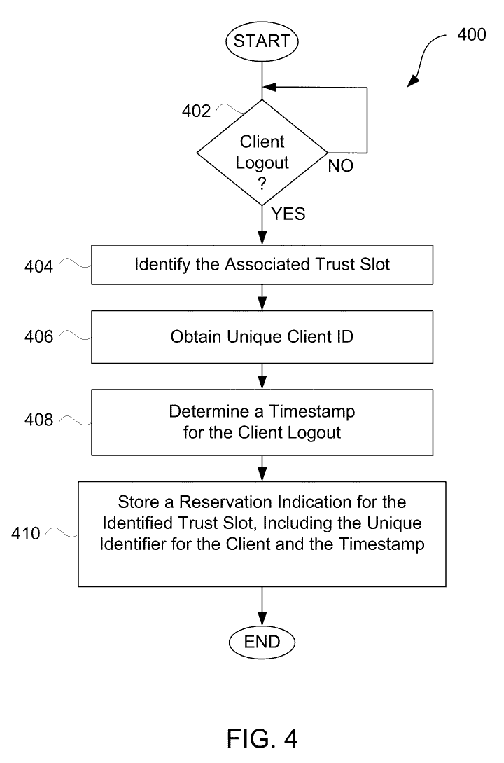

FIG. 4 is a flow diagram of a media sharing logout process 400 according to one embodiment. The media sharing logout process 400 is, for example, performed by a server computer, such as the server computer 102 illustrated in FIG. 1A.

The media sharing logout process 400 begins with a decision 402 that determines whether a client logout is occurring, will soon occur or has recently occurred. Hereafter, for convenience, this condition is simply referred to as client logout pending. When the decision 402 determines that a client logout is not pending, the media sharing logout process 400 awaits such a condition. In other words, the media sharing logout process 400 is effectively invoked once a client logout is pending.

Once the decision 402 determines that a client logout is pending, the trust slot associated to the client is identified 404. As noted above, when login was granted, the client was assigned a trust slot. Here, the trust slot that was then assigned is now identified 404. In addition, a unique identifier for the client is obtained 406. As noted above, the unique identifier for the client can take many different forms depending on implementation. A timestamp for the client logout is also determined 408. The timestamp can thus indicate the time the client logout occurred. Thereafter, a reservation indication is stored 410 for the identified trust slot. The reservation indication, for example, can include the unique identifier for the client as well as the timestamp for the client logout. Following the block 410, the media sharing logout process 400 is complete and ends.

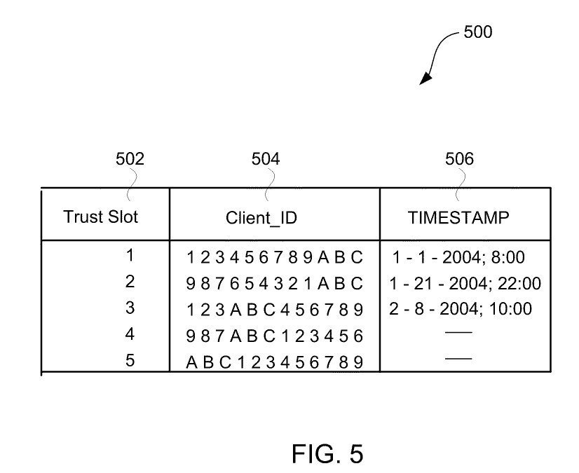

FIG. 5 is a diagram of a reservation table 500 according to one embodiment. The reservation table 500 represents one implementation of a storage mechanism that stores one or more reservation indications for associated trust slots of a given server computer. The reservation table 500 would typically be stored at the associated server computer. The reservation table 500 identifies and associates trust slots 502, client identifiers 504 and timestamps 506. As noted above, a server computer offers only a limited number of trust slots for media sharing with client computers. In the reservation table 500 there are only five (5) trust slots available. Trust slots 1, 2 and 3 are presently reserved for clients respectively identified by client identifiers (client_ID). Trust slots 1, 2 and 3 also include timestamps indicating when the reservations started. Trust slots 4 and 5 are currently assigned to clients respectively identified by client identifiers but do not have any timestamps.

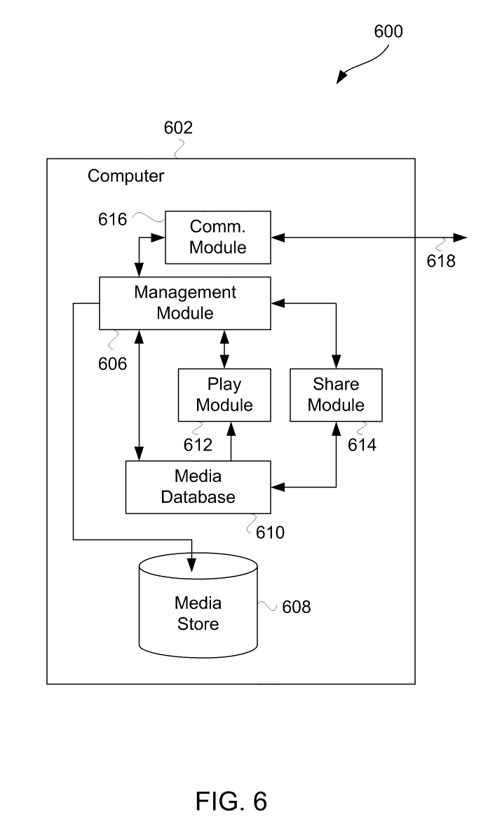

FIG. 6 is a block diagram of a media management system 600 according to one embodiment. The media management system 600 includes a computer 602. The computer 602 can pertain to a server computer or a client computer as previously discussed in other embodiments. The computer 602 is typically a personal computer. The computer 602, among other conventional components, includes a management module 606 which is a software module. The management module 606 provides for centralized management of media items (and/or playlists) on the computer 602. More particularly, the management module 606 manages those media items stored in a media store 608 associated with the computer 602. The management module 606 also interacts with a media database 610 to store media information associated with the media items stored in the media store 608.

The media information pertains to characteristics or attributes of the media items. For example, in the case of audio or audiovisual media, the media information can include one or more of: title, album, track, artist, composer and genre. These types of media information are specific to particular media items. In addition, the media information can pertain to quality characteristics of the media items. Examples of quality characteristics of media items can include one or more of: bit rate, sample rate, equalizer setting, volume adjustment, start/stop and total time.

Still further, the computer 602 includes a play module 612. The play module 612 is a software module that can be utilized to play certain media items stored in the media store 608. The play module 612 can also display (on a display screen) or otherwise utilize media information from the media database 610. Typically, the media information of interest corresponds to the media items to be played by the play module 612.

In addition, the computer 602 includes a share module 614 and a communication module 616. The share module 614 is used to support sharing of media items stored in the media store 608 with other computers over a computer network. The sharing can be implemented by sharing media content associated with one or more media items from the computer 602 to one or more other computers via the communication module 616. Typically, the share module 614 (alone or in combination with the management module 606) regulates or restricts the ability of media items to be shared with other computers. In one embodiment, the regulations or restrictions limit not only the number of other computers that can be sharing media items from the computer 602 at any point in time, but also the turn-over rate for the other computers. For example, if the maximum number of other computers permitted to share the media assets from the computer 602 is five (5) and the minimum turn-over duration is twenty-four (24) hours, then the ability for unfettered access by large numbers of other computers is effectively prevented.

The communication module 616 removeably couples to the computer network via a connection or link 618 so that data (including media items) can be transmitted to corresponding communication modules of other computers that are permitted to receive such data. In one embodiment, the connection or link 618 is a cable that provides a data bus, such as a FIREWIRE™ bus or USB bus, which is well known in the art. In another embodiment, the connection or link 618 is a wireless channel or connection through a wireless network. Hence, depending on implementation, the communication modules may communicate in a wired or wireless manner.

In one implementation, the computer 602 can utilize an application resident on the computer to permit utilization and provide management for media assets, including sharing of media assets. One such application is iTunes® produced by Apple Inc. of Cupertino, Calif.

The limited number of simultaneously shared clients (or trust slots), namely five (5), and the reservation period, namely twenty-four (24) hours, 48 hours, one week, one month or longer, noted above are exemplary parameters. Hence, it should be understood that these exemplary parameters are merely that, because various different values can be used depending on implementations and objectives.

Although the media items (or media assets) of emphasis in several of the above embodiments were audio items (e.g., audio files/tracks, including music or songs), the media items are not limited to audio items. For example, the media items can alternatively pertain to videos (e.g., movies) or images (e.g., photos).

Although the terms client computer and server computer are utilized above, these terms also include client and server, respectively. These terms include hardware, software, or hardware and software implementations.

The various aspects, embodiments, implementations or features of the invention can be used separately or in any combination.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that a media sharing in an open environment can be restricted. Another advantage of the invention is that restrictions on media sharing can discourage overuse of media sharing capabilities. Another advantage of the invention is that DRM as provided is context aware. In particular, some convenience and flexibility is desired to balance comprehensive digital rights management, especially in a context of a person's home environment. Still another advantage of the invention is that responsible sharing of media across a network is encouraged. For example, media sharing restrictions can encourage users providing media sharing to impose a password requirement so that anonymous media sharing is largely prevented.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer implemented method of managing sharing of media content from a server computer to one or more of a plurality of client computers across a computer network, said method comprising:
(a) downloading media content to the server computer;
(b) storing media content in long-term storage in the server computer;
(c) discovering a first set of a plurality of trust attributes of the server computer and a second set of a plurality of trust attributes of a particular one of the client computers; and
(d) upon determining that the first and second sets of trust attributes satisfy a trust criteria, trusting the particular client computer, and aggregating media content from the server computer to long-term storage of the particular client computer.

2. A method as recited in claim 1, wherein said aggregating comprises downloading media content to the particular client computer, for storing in long term storage in the particular client computer, provided that the media content is not already stored in long term storage in the particular client computer.

3. A method as recited in claim 1, wherein said aggregating comprises:
checking a preference setting stored on at least one of the server computer or the particular client computer; and
aggregating automatically and without any specific user input for such aggregating, when the preference setting indicates that the media content is to be aggregated automatically to the particular client computer.

4. A method as recited in claim 1 further comprising enforcing device-based Digital Rights Management (DRM) of the media content for the server computer and the client computers.

8. A method as recited in claim 1 further comprising enforcing a Digital Rights Management (DRM) policy that restricts access to the media content on the server computer for aggregating by only a limited number of trusted ones of the client computers.

9. A method as recited in claim 1 further comprising enforcing Digital Rights Management (DRM) by limiting a number of server connections available to trusted ones of the client computers for aggregating media content therein.

10. A method as recited in claim 1 further comprising enforcing Digital Rights Management (DRM) by limiting a number of trust slots available for server connections to trusted ones of the client computers for aggregating media content therein.

11. A method as recited in claim 1, wherein discovering the first set of the plurality of trust attributes of the server computer, and determining whether the first set of trust attributes satisfies the trust criteria comprise:
discovering availability of a limited number of trust slots for connection to the server computer; and
determining whether at least one of the limited number of trust slots is available for server connection use by the particular client computer, in accordance with the trust criteria.

12. A method as recited in claim 1, wherein discovering the first set of the plurality of trust attributes of the server computer, and determining whether the first set of trust attributes satisfies the trust criteria comprise:
discovering any time dependent availability of a limited number of trust slots for connection to the server computer; and
determining whether the time dependent availability of at least one of the limited number of trust slots is in accordance with the trust criteria.

13. A method as recited in claim 1, wherein discovering the first set of the plurality of trust attributes of the server computer, and determining whether the first set of trust attributes satisfies the trust criteria comprise:
discovering any event dependent availability of a limited number of trust slots for connection to the server computer; and
determining whether the event dependent availability of at least one of the limited number of trust slots is in accordance with the trust criteria.

14. A method as recited in claim 1, wherein discovering the first set of the plurality of trust attributes of the server computer, and determining whether the first set of trust attributes satisfies the trust criteria comprise:
discovering any authorization of the server computer for sharing media content; and
determining whether the server computer is authorized for sharing media content, in accordance with the trust criteria.

15. A method as recited in claim 1, wherein discovering the second set of the plurality of trust attributes of the particular one of the client computers, and determining whether the second set satisfies the trust criteria comprise:
discovering network connectivity of the particular one of the client computers; and
determining whether network connectivity of the particular one of the client computers in accordance with the trust criteria.

16. A method as recited in claim 1, wherein discovering the second set of the plurality of trust attributes of the particular one of the client computers, and determining whether the second set satisfies the trust criteria comprise:
discovering a location, or an approximate location, or an estimate location of the particular one of the client computers; and
determining whether such location of the particular one of the client computers in accordance with the trust criteria.

17. A method as recited in claim 1, wherein discovering the second set of the plurality of trust attributes of the particular one of the client computers, and determining whether the second set satisfies the trust criteria comprise:
discovering any authorization of the particular one of the computers for sharing media content; and
determining whether the particular one of the client computers is authorized for sharing media content in accordance with the trust criteria.

18. A method as recited in claim 1, wherein determining that the first and second sets of trust attributes satisfy the trust criteria comprises at least one of:
determining whether at least one of a limited number of server connections is available for use by the particular client computer in accordance with the trust criteria;
determining whether at least one of the limited number of trust slots is available for server connection use by the particular client computer in accordance with the trust criteria;
determining whether time dependent availability of at least one of the limited number of trust slots is in accordance with the trust criteria;
determining whether event dependent availability of at least one of the limited number of trust slots is in accordance with the trust criteria;
determining whether network connectivity of the particular one of the client computers is in accordance with the trust criteria;
determining whether a location, or an approximate location, or an estimate location of the particular one of the client computers is in accordance with the trust criteria; and
determining whether proximity of the particular one of the client computers relative to the server computer is in accordance with the trust criteria.

19. A computer implemented method for restricting sharing of media content from a server computer to one or more of a plurality of client computers across a computer network, said method comprising:
(a) downloading media content to the server computer;
(b) storing media content in long-term storage in the server computer;
(c) determining whether at least one of a limited number of trust slots is available for use by a particular client computer;
(d) assigning an available one of the trust slots for use by the particular client computer when said determining (c) determines that at least one of the limited number of trust slots is available for use by the particular client computer;
(e) establishing a connection for the particular client computer using the assigned trust slot;
(f) sharing media content from the server computer with the particular client computer via the established connection; and
(g) reserving the assigned trust slot for the particular client computer for at least a predetermined period of time after an event.

20. A method as recited in claim 19, wherein said determining (c) whether at least one of the limited number of trust slots is available for use by the particular client computer comprises making available a trust slot that was previously reserved.

21. A method as recited in claim 19,
wherein the reserving (g) comprises reserving the assigned trust slot for the particular client computer for at least a predetermined period of time after a client release event, and
wherein the determining (c) whether at least one of the limited number of trust slots is available for use by the particular client computer comprises making available a trust slot that was previously reserved, if the trust slot has been reserved for more that the predetermined period of time after the client release event.

22. A method as recited in claim 19, wherein said reserving (g) includes at least storing a reservation indication at the server computer for the assigned trust slot, the reservation indication including at least a time indication and a unique identifier for the particular client computer.

23. A context aware computer implemented method of managing sharing of media content from a Digital Rights Management (DRM) server computer to one or more of a plurality of client computers across a computer network, said method comprising:
downloading media content to the DRM server computer;
storing media content in long-term storage in the DRM server computer;
discovering a plurality of time dependant and/or location dependent and/or event dependent attributes of a trust context of the DRM server and a particular one of the client computers; and
determining whether the plurality of attributes of the trust context of the DRM server and the particular one of the client computers satisfy a trust criteria; and
sharing media content from the DRM server computer with the particular client computer if the determining determines that the trust criteria is satisfied.

24. A computer readable medium including at least computer program code stored thereon for managing sharing of media content from a Digital Rights Management (DRM) server computer to one or more client computers across a computer network, said computer readable medium comprising:
computer program code for discovering a plurality of attributes of a trust context of the DRM server and a particular one of the client computers; and
computer program code for sharing media content from the server computer with the particular client computer, upon determining that the plurality of attributes of the trust context of the DRM server and the particular one of the client computers satisfy a trust criteria.

25. An electronic device comprising:
a network interface for coupling said electronic device to a computer network;
a memory for storing media content;
digital rights management control logic configured to permit limited sharing of at least a portion of the media content stored in the memory to one or more other electronic devices coupled to the computer network; and
trust attribute discovery logic configured to discover a plurality of attributes of a trust context of the electronic device and a particular one of the other electronic devices,
wherein the digital rights management control logic is further configured to share at least a portion of the media content stored in the memory to the particular one of the other electronic devices, upon determining that the plurality of attributes of the trust context of the particular one of the other electronic devices satisfy a trust criteria.

26. A computer implemented method for restricting sharing of digital media assets across one or more networks, said method comprising:
establishing a limited group of computers permitted to share digital media assets across one or more networks;
purchasing, via a first computer from the limited group of computers, a digital media asset from a media commerce service;
permitting the purchased media asset to be provided to any of the other computers within the limited group of computers; and
automatically providing the purchased media asset to any of the other computers within the limited group of computers when connected to the one or more networks.

27. A computer implemented method as recited in claim 26, wherein said providing comprises delivery from the media commerce service to any of the other computers within the limited group of computers when connected to the one or more networks.

28. A computer implemented method as recited in claim 26, wherein said providing comprises delivery from the first computer to any of the other computers within the limited group of computers when connected to the one or more networks.

28. A computer implemented method as recited in claim 26, wherein said providing comprises:
sending, by the first computer, a notification to any of the other computers within the limited group of computers, the notification providing an indication that the first computer is available for sharing; and
automatically initiating copying of the purchased media asset to at least one of the other computers within the limited group of computers.

29. A computer implemented method as recited in claim 28,
wherein the notification includes a date and/or time on which the first
computer last purchased a digital media asset,
wherein for the at least one of the other computers within the limited group of computers, a stored data and/or time representing a last update with respect to the first computer is maintained, and
wherein said copying is initiated for a given one of the other computers within the limited group of computers if date and/or time within the notification is more recent that the stored date and/or time corresponding to the last update with respect to the first computer.
